(19) United States
(12) Patent Application Publication
(10) Pub. No.: US 2012/0152962 A1
(43) Pub. Date: Jun. 21, 2012

(54) Campfire cooking handle and accessories

(76) Inventor: Kenneth Arbuckle, Ashland, WI (US)

(21) Appl. No.: 12/928,826

(22) Filed: Dec. 20, 2010

(51) Int. Cl. A47J 27/02; B25G 1/08; G09F 3/00; A47J 43/28

(52) U.S. Cl. 220/573.2; 30/322; 16/111.1; 40/299.01

(57) ABSTRACT

A campfire cooking handle and accessories is provided. The new campfire cooking handle is an elongated handle that can be utilized while cooking foods over a campfire or a fireplace etc. The new campfire cooking handle is approximately three feet long and allows a person to be far enough away from the fire so that the person's hand does not get burned or too hot while cooking food items over an open fire. The new campfire cooking handle is used with other cooking accessories such as different size forks for holding steaks; marshmallows, hotdogs, bratwurst and fruits and vegetables such as such as apples and potatoes, etc. The new campfire cooking handle can also be utilized with other accessories such as a grilling pan, a frying pan, a popcorn popper, etc. The campfire cooking handle has a bend thereon so that when a person is standing while the handle is utilized for cooking over an open fire, the item being grilled is substantially in a horizontal position. This design prevents items such as hotdogs and marshmallows from falling off a grilling fork while the item is being cooked over the fire. The campfire cooking handle can be utilized many different ways and can be utilized with many different accessories and can be modified many different ways.

### CROSS REFERENCE TO RELATED APPLICATIONS

Not Applicable

### FEDERALLY SPONSORED RESEARCH

Not Applicable

### SEQUENCE LISTING

Not Applicable

1. Field of the Invention

This invention relates generally to the field of campfire cooking utensils, campfire cooking devices, campfire cooking forks, campfire cooking tools and campfire cooking accessories, etc.

2. Description of Prior Art

Cooking food over an open flame such a campfire, of a fire pit or a fire place is popular. There numerous cooking forks, pots and pans and various utensils available that enable foods to be cooked over open flames such as campfire. Some of the cooking devices may work adequately for some consumers, however many of the devices are inadequate in many ways. A typical grilling fork that can be utilized to cook a hotdog or a marshmallow over an open campfire usually approximately 20 inches long. The 20 inch length of the fork is too short most of the time as a hand would get too hot when the person is trying to cook the hotdog over the open fire. Additionally, if a person is standing while trying to roast a marshmallow over a campfire, the fork holding the marshmallow is usually pointed downward toward the camp fire while it is being roasted. Often the hotdog or marshmallow slides off the fork into the fire with out warning and the item is lost into the fire. Cooking over a campfire with other utensils such as a grilling pan, a frying pan, or a popcorn popper, also encounter similar problems such as the handles being to short.

### SUMMARY OF THE INVENTION

A campfire cooking handle and accessories is provided. The new campfire cooking handle is an elongated handle that can be utilized while cooking foods over a campfire or a fireplace etc. The new campfire cooking handle is approximately three feet long and allows a person to be far enough away from the fire so that the person's hand does not get burned or too hot while cooking food items over an open fire. The new campfire cooking handle is used with other cooking accessories such as different size forks for holding steaks, marshmallows, hotdogs, bratwurst and fruits and vegetables such as such as apples and potatoes, etc. The new campfire cooking handle can also be utilized with other accessories such as a grilling pan, a frying pan, a popcorn popper, etc. The campfire cooking handle has a bend thereon so that when a person is standing while the handle is utilized for cooking over an open fire, the item being grilled is substantially in a horizontal position. This design prevents items such as hotdogs and marshmallows from falling off a grilling fork while the item is being cooked over the fire. The campfire cooking handle can be utilized many different ways and can be utilized with many different accessories and can be modified many different ways

Objects of the Invention

It is an object of the invention to provide a campfire cooking handle that enables a person to be far enough away from an open fire so a hand would not get over heated.

It is an object of the invention to provide a campfire cooking handle that enables a person to roast items such as steaks, hotdogs, and marshmallows, etc. and not have the item fall off the fork into the fire.

It is an object of the invention to provide a campfire cooking handle that enables a person to roast items such s steaks, hotdogs, and marshmallows, etc. with different size forks or more than one fork, or a skewer.

It is an object of the invention to provide a campfire cooking handle that enables a person to cook food with different size pots and pans.

It is an object of the invention to provide a campfire cooking handle that enables a person to cook bread over an open fire.

It is an object of the invention to provide a campfire cooking handle that is light weight and easy to transport.

It is an object of the invention to provide a campfire cooking handle that is generally easy to manufacture.

It is an object of the invention to provide a campfire cooking handle that is generally easy to manufacture in different sizes.

### BRIEF DESCRIPTION OF THE DRAWINGS

FIG. 1 is a view of a person holding the new campfire cooking handle with a large fork attached. The fork holds a steak which is being cooked by a fire.

FIG. 2 is a view of the new campfire cooking handle and large fork. The fork is not attached.

FIG. 3 is a close up view of the utensil holding end of the new multi-use campfire cooking tool.

FIG. 4 is a close up view of the utensil holding end of the new campfire cooking handle with a grilling pan inserted into the slot in the utensil holding end.

FIG. 5 Is a close up view of the utensil holding end of the new campfire cooking handle with the handle of a frying pan bolted onto the utensil holding end.

FIG. 6 Is a close up view of the utensil holding end of the new campfire cooking handle with two forks fastened onto the utensil holding end.

FIG. 7 Is a view of wire holder and a disposable aluminum bread pan. The wire handle section of the wire holder is designed to fit into the slot in the utensil holding end of the new campfire cooking handle.

FIG. 8 is a view wire holder and a disposable aluminum bread pan shown in FIG. 7. The aluminum bread pan is inserted into the wire holder. The aluminum bread pan has a loaf of bread therein.

FIG. 9 is a view of the new campfire cooking handle with a grilling pan attached with a fish therein being cooked by a campfire. The new campfire cooking handle is being held by a supporting fork and a rock.

The objects and advantages of the invention will become apparent when the drawings are studied in conjunction with reading the following description and the claims.

### DESCRIPTION OF THE PREFERRED EMBODIMENTS

In keeping with the requirements of Patent Laws there is described herein below the best mode of the invention that is currently known to the applicant. For the purposes of promoting an understanding of the principles of the invention, reference will now be made to the embodiment. illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

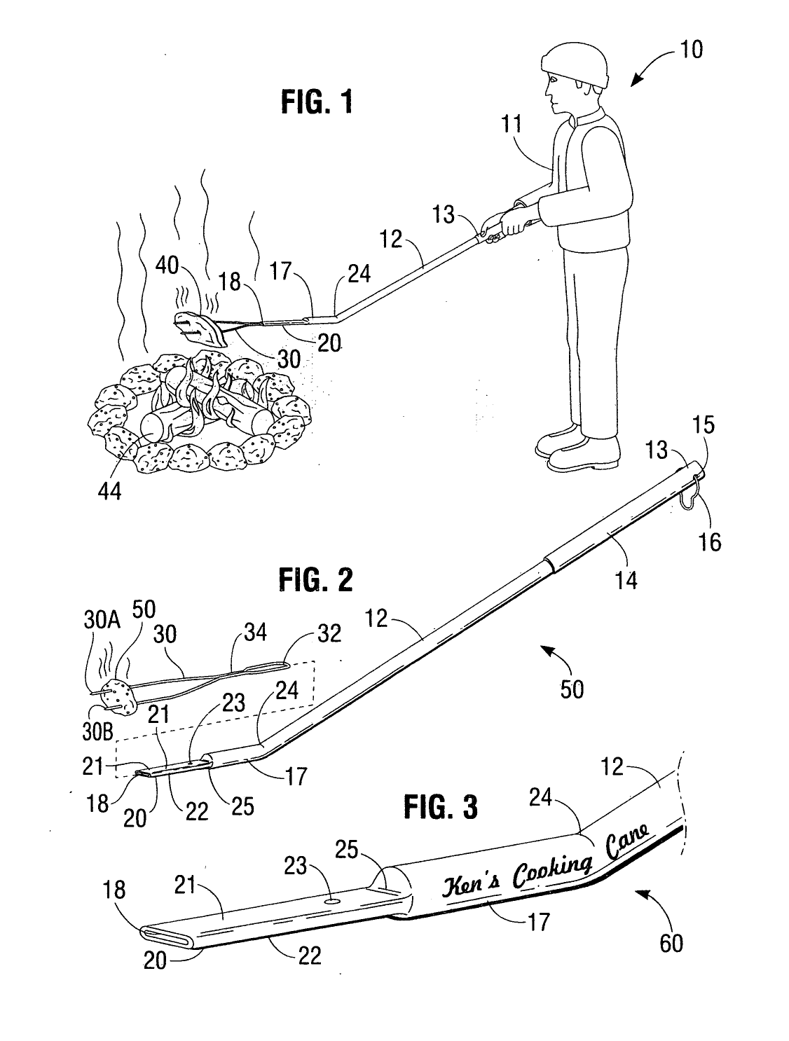

With reference now to the drawings, and in particular, to FIGS. 1-9 thereof, the preferred embodiment of the new campfire cooking handle embodying the principles and concepts of the present invention and generally designated by the reference number 10 will be described.

In FIG. 1 shown generally at 10 is a view of a person 11 holding the new campfire cooking handle 12 with a large fork 30 attached. The fork 30 holds a steak 40 which is being cooked by a camp fire 44. campfire cooking handle 12 has a handle end 13 and a utensil holding end 17. Utensil holding end 17 has a receiving slot 18 with fork handle 32 inserted therein. The campfire cooking handle 12 has a bend 24 thereon.

In FIG. 2 shown generally at 50 is a view the new campfire cooking handle 12 with a large fork 30. Campfire cooking handle 12 has a handle end 13 and a utensil holding end 17. Campfire cooking handle 12 is approximately three feet long and can easily be made with different lengths if so desired. The Campfire cooking handle 12 is made of a metal tube that has a diameter of approximately one inch. The Campfire cooking handle 12 can be made of different materials but a light weight metal such as aluminum is generally suitable. Handle end 13 has a gripping section 14 which can be made of a different material than the metal handle. Campfire cooking handle 12 has a hole 15 therethrough and a ring 16. Ring 16 can be utilized to hang the new campfire cooking handle 12 when it is not being used. Ring 16 can also be utilized to hold cooking utensils when they are not being used. Utensil holding end 17 has a receiving slot 18 which has a long axis that is approximately 1⅛ inch long and a short axis which is approximately ⅛ inch. Utensil holding end 17 has a first section 20 that has a first flat surface 21 and a second flat surface 22. Flat section 20 is approximately 5 inches long, and has a hole 23 therethrough. Flat section 20 ends with a notch transition 25 with handle. Handle has bend 24 thereon. The length from the tip 18 to bend 24 is approximately 8 inches. Large fork 30 is approximately 16 inches long and has a handle end 32 a mid section 34 and fork tip 36 and fork tip 38. Fork 30 holds baked potato. 52. Handle end 32 is designed to have a tight press fit into slot 18 of the new campfire cooking handle 12.

In FIG. 3 shown generally at 60 is a closeup view the utensil holding end 17 of the new campfire cooking handle 12. Utensil holding end 17 has a receiving slot 18 which has a long axis and a short axis. Utensil holding end 17 has a flat section 20 that has a first flat surface 21 and a second flat surface 22. Flat section 20 has a hole 23 therethrough. Flat section 20 ends with a notch transition 25 with handle. Handle has bend 24 thereon. The new campfire cooking handle 12 can have a product name shch as “Ken's Cooking Cane” or a company name or a logo, etc.

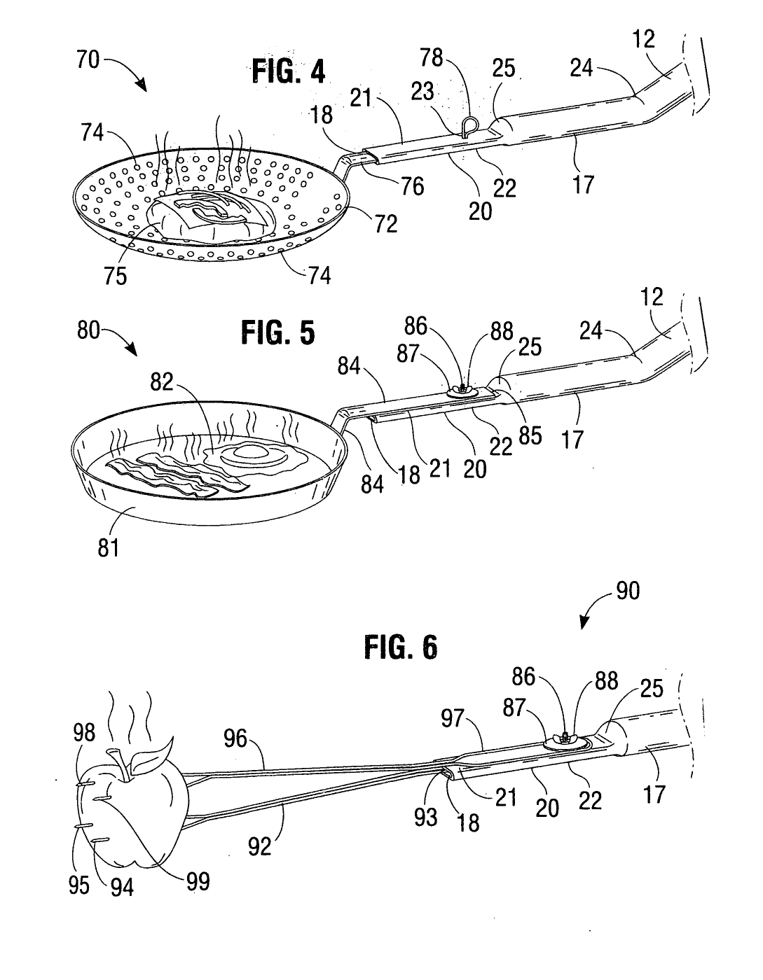

In FIG. 4 shown generally at 70 is a closeup view of the utensil holding end 17 of the new campfire cooking handle 12 holding a grilling pan 72. Utensil holding end 17 has a receiving slot 18 which has the handle 76 of pan 72 inserted therein. Utensil holding end 17 has a flat section 20 that has a first flat surface 21 and a second flat surface 22. Flat section 20 has a hole 23 therethrough. Pin 78 is inserted through hole 23 in flat section 20 and though hole (not seen) in pan handle 76. Pin 78 holds pan handle 76 securely to flat section 20. Flat section 20 ends with a notch transition 25 with handle. Handle has bend 24 thereon. Grilling pan has a non-stick coating and holes 74 therethrough. Grilling pan 72 has a flame grilled cheeseburger with mushrooms 75 therein.

In FIG. 5 shown generally at 80 is a closeup view the utensil holding end 17 of the new campfire cooking handle 12 holding a frying pan 81. Utensil holding end 17 has a receiving slot 18. Utensil holding end 17 has a flat section 20 that has a first flat surface 21 and a second flat surface 22. Flat section 20 has a hole 23 therethrough (not seen). Pan handle 84 is positioned on top of first flat surface 21 of flat section 20. Bolt 86 is positioned through hole 23 in flat section 20, through hole in pan 89 (not seen). Washer 87 is positioned over bolt 86 and wingnut 88 is tightened onto bolt 86 which secures pan handle 84 onto flat section 20 of the utensil holding end 17 of the new campfire cooking handle 12. The end of the pan handle 84 meets notch transition 25 with handle. Handle has bend 24 thereon. Frying pan has bacon and eggs therein.

In FIG. 6 shown generally at 90 is a closeup view the utensil holding end 17 of the new campfire cooking handle 12 holding a first fork 92 and a second hook 96. Utensil holding end 17 has a receiving slot 18 with handle end 93 of first fork 92 inserted therein. Utensil holding end 17 has a flat section 20 that has a first flat surface 21 and a second flat surface 22. Handle end 97 of second fork 96 is positioned on top of first flat section 21. Flat section 20 has a hole 23 therethrough (not seen. Bolt 86 is positioned through hole 23 in flat section 20, and through handle section 97 of second fork 96. Washer 87 is positioned over bolt 86 and wingnut 88 is tightened onto bolt 86 which secures fork handle 97 onto flat section 20 of the utensil holding end 17 of the new multi-use campfire cooking tool 12. First fork 92 has fork tip 94 and fork tip 95. Second fork 92 has fork tip 98 and fork tip 99. Forks hold baked apple 91.

Show generally at 100 in FIG. 7 a disposable aluminum bread pan 102 and a wire holder 104. The disposable aluminum bread pan 102 is inserted into pan holding section 106 section of wire holder 104 during use. The wire handle section 106 of the wire holder 104 is designed to fit into the slot 18 in the utensil holding end 17 he end of the new campfire cooking handle 12. The wire handle section 106 has welded section 108.

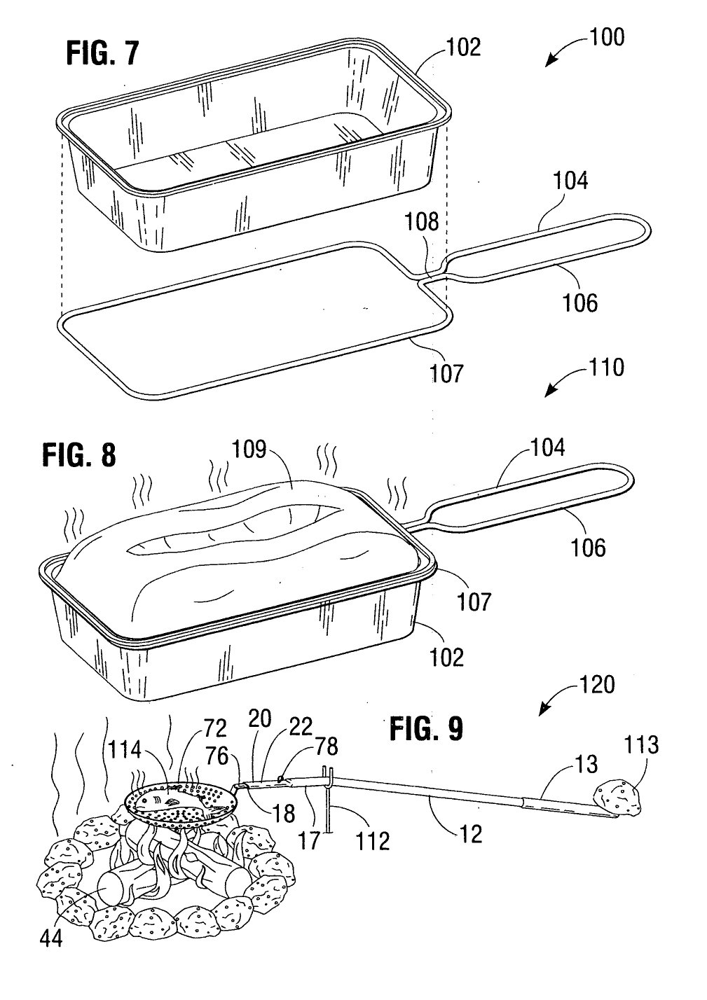

Show generally at 110 in FIG. 8 a disposable aluminum bread pan 102 inserted into pan holding section 106 of wire holder 104. The wire handle section 106 of the wire holder 104 is designed to fit into the slot 18 in the utensil holding end 17 he end of the new campfire cooking handle. The disposable aluminum bread pan 102 has a fresh baked loaf bread 109 therein.

In FIG. 9 shown generally at 120 is a view of the new campfire cooking handle 12 holding a grilling pan 72 similar to FIG. 4. Pan handle 76 has been rotated 180 degrees from the orientation shown in FIG. 4. Utensil holding end 17 has a flat section 20 that has a first flat surface 21 and a second flat surface 22. Second flat section 22 is oriented upward in this method of use. Pan handle 76 has been rotated 180 degrees from the orientation shown in FIG. 4. Flat section 20 has a hole 23 therethrough. Pin 78 is inserted through hole 23 in flat section 20 and though hole (not seen) in pan handle 76. Pin 78 holds pan handle 76 securely to flat section 20 Handle has bend 24 thereon. The new campfire cooking handle is being held by a supporting fork 112 and a rock 113. Grilling pan 72 has a fish 114 therein being grilled above campfire 44.

It is clear that the invention does provide a campfire cooking handle that enables a person to be far enough away from an open fire so a hand would not get over heated.

It is clear that the invention does provide a campfire cooking handle that enables a person to roast items such as steaks, hotdogs, and marshmallows, etc. and not having the item fall off the fork into the fire.

It is clear that the invention does provide a campfire cooking handle that enables a person to roast items such s steaks, hotdogs, and marshmallows, etc. with different size forks or more than one fork, or a skewer.

It is clear that the invention does provide a campfire cooking handle that enables a person to cook food with different size pots and pans.

It is clear that the invention does provide a campfire cooking handle that enables a person to cook bread over an open fire.

It is clear that the invention does provide a campfire cooking handle that is light weight and easy to transport.

It is clear that the invention does provide a campfire cooking handle that is generally easy to manufacture.

It is clear that the invention does provide a campfire cooking handle that is generally easy to manufacture in different sizes.

This invention having been described in its presently contemplated best mode, it is clear that it is susceptible to numerous, variations, modifications, modes and embodiments within the ability of those skilled in the art and without departing from the true spirit and scope of the novel concepts or principles of this invention. Also, it is to be understood that the phraseology and terminology employed herein are for the purpose of description and should not be regarded as limiting. It should be understood that the preferred embodiment has been shown and described and that all changes and modifications that come within the spirit of the invention are desired to be protected. The invention is capable of other embodiments and of being practiced and carried out in various ways. As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention. Accordingly, the scope of the invention is defined by the scope of the following claims.

What is claimed as new and desired to be secured by United States Letters Patent is:

1. An open fire cooking handle comprising:
a rigid member having a hand gripping section and a cooking utensil holding section;
said cooking handle is made of a metal material;
said cooking handle having a bend thereon;
said cooking utensil holding section having a cooking utensil holding end;
said cooking utensil section having a utensil holding aperture thereon; said utensil holding to aperture having a long axis and a short axis.

2. The open fire cooking handle of claim 1 wherein said handle is made of aluminum, or, steel, or, stainless steel.

3. The open fire cooking handle of claim 1 wherein said handle is made of a tubular metal material.

4. The open fire cooking handle of claim 1 wherein said cooking utensil holding section has a portion that has substantially a flat surface.

5. The open fire cooking handle of claim 1 wherein said cooking utensil holding section has an aperture therethrough.

6. The open fire cooking handle of claim 1 wherein said cooking handle has a product name thereon, or a company name thereon, or a logo thereon, or information thereon.

7. The open fire cooking handle of claim 1 including a cooking utensil; said cooking utensil is coupled to said cooking utensil holding section.

8. The open fire cooking handle of claim 1 including a fork; said fork is coupled to said cooking utensil holding section.

9. The open fire cooking handle of claim 1 including a pan; said pan is coupled to said cooking utensil holding section.

10. The open fire cooking handle of claim 1 including a grilling pan; said grilling pan having apertures therethrough; said grilling pan is coupled to said cooking utensil holding section.

11. The open fire cooking handle of claim 1 including a including a bread pan holder; said bread pan holder is coupled to said cooking utensil holding section.

12. The open fire cooking handle of claim 1 including a including a bread pan holder and a bread pan; said bread pan holder and said bread pan are coupled to said cooking utensil holding section.

13. The open fire cooking handle of claim 1 including a cooking utensil that has a nonstick coating thereon; said cooking utensil is coupled to said cooking utensil holding section.

14. The open fire cooking handle of claim 1 including a cooking utensil; said cooking utensil having a handle; said handle of said cooking utensil is inserted into said cooking utensil holding aperture

15. An open fire cooking handle comprising:
a rigid member having a hand gripping section and a cooking utensil holding section;
said cooking handle is made of a tubular metal material;
said cooking handle having a bend thereon;
said cooking utensil holding section having a cooking utensil holding end;
said cooking utensil section having a utensil holding aperture thereon; said utensil holding aperture having a long axis and a short axis.

16. The open fire cooking handle of claim 15 wherein said handle is made of aluminum, or, steel, or, stainless steel.

17. The open fire cooking handle of claim 15 including a cooking utensil; said cooking utensil is coupled to said cooking utensil holding section.

18. The open fire cooking handle of claim 15 wherein said cooking handle has a product name thereon, or a company name thereon, or a logo thereon, or information thereon.

19. An open fire cooking handle comprising:
a rigid member having a hand gripping section and a cooking utensil holding section;
said cooking handle is made of a metal material;
said cooking handle having a bend thereon;
said cooking utensil holding section having a cooking utensil holding end;
said cooking utensil section having means for fastening a cooking utensil thereto.

20. The open fire cooking handle of claim 19 including a cooking utensil; said cooking utensil is coupled to said cooking utensil holding section.
